(19) United States
(12) Patent Application Publication
(10) Pub. No.: US 2026/0332421 A1
(43) Pub. Date: Oct. 22, 2026

(54) Governance Layer System for Biological Behavioral Fusion and Safety Conditioned Orchestration

(71) Applicant: Dario Chang, Doral, FL (US)

(72) Inventor: Dario Chang, Doral, FL (US)

(21) Appl. No.: 19/654,670

(22) Filed: Apr. 22, 2026

Related U.S. Application Data
(63) Continuation-in-part of application No. 19/390,733, filed on Nov. 17, 2025.

(51) Int. Cl. H04L 9/32

(52) U.S. Cl. CPC H04L 9/3231; H04L 9/3213; H04L 9/3218; H04L 9/3236

(57) ABSTRACT

A governance-layer system that fuses biological micro-signals and behavioral signals into a unified Biological-Behavioral Fusion Vector (BBFV), applies drift-aware safety gating via a Safety-Gated Orchestration Kernel (SGOK), and provides privacy-preserving regulator access through a Regulator Transparency Interface (RTI). The BBFV integrates physiological, behavioral, contextual, and temporal stability inputs to produce safety tiers and confidence measures. The SGOK enforces safety-conditioned orchestration, issues safety envelopes, and triggers machine-state transitions when drift or risk thresholds are exceeded. The RTI exposes hashed, consent-scoped artifacts and tamper-evident proof digests anchored to a ledger for regulator verification without revealing raw biological data. Embodiments include peptide, hormonal, neurological, emotional, and environmental modalities. The system supports schema versioning, validation protocols, and multi-agent coordination.

### CROSS-REFERENCE TO RELATED APPLICATIONS

This application is a Continuation-in-Part of U.S. patent application Ser. No. 19/397,884 entitled Governance-Layer Operating System for Predictive Scoring, Machine-State Transitions, and Regulator-Aligned Transparency, which is a Continuation-in-Part of U.S. patent application Ser. No. 19/390,733, filed Nov. 17, 2025, the entirety of which is incorporated herein by reference.

### FIELD OF THE INVENTION

The invention relates to governance-layer scoring systems and adaptive orchestration. More specifically, the invention provides a modular architecture for fusing biological micro-signals and behavioral signals into a unified governance vector, generating regulator-verifiable safety artifacts, and enforcing safety-conditioned orchestration across multi-agent systems, marketplaces, and digital platforms.

### BACKGROUND

Existing governance systems compute behavioral, economic, or operational scores but do not incorporate biological micro-signals as first-class governance inputs.

Physiological sensing systems exist, but they operate in isolation and do not: fuse biological and behavioral signals; generate regulator-verifiable safety proofs; enforce machine-state transitions; or provide cross-domain orchestration conditioned on biological-behavioral safety.

Application Ser. No. 19/397,884 introduced a governance-layer architecture based on predictive scoring, machine-state transitions, compliance proofs, and regulator-aligned transparency.

This Continuation-in-Part extends that architecture by introducing a generalized Biological-Behavioral Fusion Vector, a Safety-Gated Orchestration Kernel, and a Regulator Transparency Interface. In one embodiment, the biological micro-signals comprise peptide-modulated physiological responses.

### SECTION 1A PARENT MAPPING

The Biological-Behavioral Fusion Vector (BBFV) disclosed herein is consumed by the governance-layer scoring kernel described in U.S. patent application Ser. No. 19/397,884 as an additional governance input. In this Continuation-in-Part, the BBFV extends the parent's IPS-based scoring architecture by introducing biological micro-signals and contextual stability as new classes of governance-layer signals.

The Safety-Gated Orchestration Kernel (SGOK) extends the machine-state transition logic of Ser. No. 19/397,884 by incorporating biological-behavioral drift coefficients as triggers for LISTED→UNLISTED, ACTIVE→SUSPENDED, and NORMAL→RESTRICTED transitions. The Regulator Transparency Interface (RTI) extends the parent's proof registry by adding privacy-preserving selective disclosure of biological-behavioral safety artifacts.

### SECTION 2 SUMMARY OF THE INVENTION

Summary—The invention provides a governance-layer architecture comprising three core primitives: (1) Biological-Behavioral Fusion Vector (BBFV); (2) Safety-Gated Orchestration Kernel (SGOK); and (3) Regulator Transparency Interface (RTI). The architecture is general and supports multiple biological modalities; peptides are described as a flagship embodiment.

The BBFV is a unified vector representing biological micro-signals, behavioral signals, contextual modifiers, and temporal stability. The SGOK conditions system behavior on BBFV-derived safety tiers, enforces machine-state transitions, and generates safety envelopes. The RTI is a privacy-preserving interface that exposes selective disclosures, drift reports, explainability traces, and tamper-evident safety artifacts.

### SECTION 3 DETAILED DESCRIPTION OVERVIEW

The detailed description below defines the BBFV subcomponents, fusion mechanisms, SGOK gating logic, RTI disclosure primitives, canonical schema and versioning, drift governance, consent-scoped proofs, validation protocols, threat model, cross-agent coordination, and representative embodiments. All examples, pseudocode, and mathematical expressions are illustrative and non-limiting.

### Section 3.1 Biological-Behavioral Fusion Vector BBFV

The BBFV comprises four sub-vectors: Biological Micro-Signal Vector (BMSV), Behavioral Influence Vector (BIV), Contextual Modulation Vector (CMV), and Temporal Stability Vector (TSV). Each sub-vector may be represented in any dimensionality and encoded using any suitable representation.

Biological Micro-Signal Vector BMSV—BMSV includes physiological micro-signals such as heart-rate variability deltas, micro-tremor frequency, electrodermal variance, pupillometry drift, micro-facial EMG, thermoregulation variance, cognitive-load indicators, and stress-response markers. All BMSV computations may be performed within a Trusted Execution Environment (TEE) or equivalent secure processing environment.

Behavioral Influence Vector BIV—BIV includes task completion rhythms, attention stability, decision latency, productivity cycles, and affective modulation patterns.

Contextual Modulation Vector CMV—CMV includes circadian alignment, environmental stressors, nutritional timing, movement cycles, and social context.

Temporal Stability Vector TSV—TSV includes volatility, drift coefficient, adaptation rate, and resonance patterns.

Fusion Mechanism—The system fuses BMSV, BIV, CMV, and TSV using attention-weighted fusion, gated Mixture-of-Experts, temporal graph transformers, conformal prediction, or any other fusion operator. Fusion is performed to produce a governance vector that includes safety tier indicators, confidence intervals, drift coefficients, and provenance metadata.

Section 3.1 Mathematical Representation

Let: [BMSV \in \mathbb{R}^{{n},\quad BIV \in \mathbb{R}}{m},\quad CMV \in \mathbb{R} ^{{k},\quad TSV \in \mathbb{R}}{p}. ]

Define a generalized fusion operator: [\mathcal{F}: \mathbb{R}^{{n}\times\mathbb{R}}{m}\times\mathbb{R}^{{k}\times\mathbb{R}}{p}\rightarrow\mathbb{R}\textcircled{ }{d},] and [BBFV=\mathcal{F}(BMSV, BIV, CMV, TSV).]

Non-limiting illustrative examples include: [BBFV=\sigma\big(W_1 BMSV+W_2 BIV+W_3 CMV+W_4 TSV+b\big),] or attention-weighted fusion: [BBFV=\sum_{i=1}^{{4}\alpha_i V_i,\quad \alpha=\text{softmax}\big(QK}\top/\sqrt{d}\big),] where (V_i) are the sub-vectors and (\sigma) is an activation or normalization function.

Drift-Aware Correction—A drift correction term may be computed and incorporated: [\Delta_{drift}=\gamma\cdot (TSV_t−TSV_{t−1}),] [BBFV′=BBFV+\Delta_{drift}.]

### Section 3.1 Pseudocode

### #Illustrative Non-Limiting Pseudocode

def compute_BBFV(BMSV, BIV, CMV, TSV, TSV_prev):
base=W1 @ BMSV+W2 @ BIV+W3 @ CMV+W4 @ TSV
drift=gamma*(TSV−TSV_prev)
return activate(base+drift)

### Section 3A Canonical Schema Versioning

The system may define a canonical schema for BBFV components including field names, units, dimensionality, and version identifiers. A non-limiting example field set is: {bmsv_v1.hrv_delta, bmsv_v1.edr_variance, biv_v1.attention_score, cmv_v1.circadian_phase, tsv_v1.volatility}. Schema versioning supports interoperability and backward compatibility.

### Section 3B Drift Governance Module

The system computes a drift coefficient (\delta_t) representing longitudinal deviation in biological-behavioral patterns. A non-limiting example: [\delta_t=\lVert TSV_t−\overline{TSV}_{t−L}\rVert_2,] where (L) is a lookback window. The drift coefficient is incorporated into BBFV and used by SGOK to determine safety tiers.

The SGOK may apply configurable thresholds (\theta_1,\theta_2) such that:
(\delta_t>\theta_2) triggers RED tier and machine-state transition;
(\delta_t>\theta_1) triggers AMBER tier and human-in-the-loop review;
otherwise the system remains GREEN.

Thresholds are illustrative and non-limiting.

### Section 3.2 Safety-Gated Orchestration Kernel SGOK

The SGOK consumes BBFV and enforces safety-conditioned orchestration. The SGOK produces safety artifacts and enforces machine-state transitions based on BBFV and drift.

Safety Artifacts—The SGOK generates Biological State Envelopes (BSEs), Safety Intervention Envelopes (SIEs), Drift Reports, and Explainability Traces. Each envelope contains hashed BBFV components, safety tier, drift coefficient, proof digest, timestamps, and machine-state transition triggers.

Tier Function—A non-limiting tier function: [\tau=g(BBFV,\delta_t) \in{\text{GREEN, AMBER, RED}},] with example mapping: [\tau=\begin{cases}\text{RED}, & \delta_t>\theta_2\ \text{AMBER}, & \delta_t>\theta_1\ \text{GREEN}, & \text{otherwise} \end{cases}]

### SGOK Pseudocode (Illustrative)

def orchestrate(BBFV, task):
   tier=compute_safety_tier(BBFV)
   if tier==“RED”:
      anchor_safety_envelope(BBFV)
      transition_state(“UNLISTED”)
      Return Suspend(task)
   if tier==“AMBER”:
      anchor_safety_envelope(BBFV)
      Return Execute_with_human_review(task)
   return execute(task)

### Section 3.3 Regulator Transparency Interface RTI

The RTI provides privacy-preserving selective disclosure to regulators and auditors. The RTI returns hashed BBFV components, safety tier, drift coefficient, proof digest, and signed state transitions.

Selective Disclosure Function—Non-limiting representation: [\Phi(BBFV)={\text{hash}(BBFV),\ \tau,\ \delta_t,\ \text{proof_digest}, \ \text{state_history}}.]

Ledger Anchoring—Safety envelopes may be anchored to a tamper-evident ledger using a Merkle root or equivalent commitment: [\Lambda(SE)=\text{MerkleRoot}(SE).]

### RTI Pseudocode (Illustrative)

def regulator_query( ):
   return {
      “bbfv_hash”: hash(BBFV),
      “safety_tier”: BBFV.tier,
      “drift”: BBFV.drift,
      “proof_digest”: BBFV.proof,
      “state_transitions”: recent_transitions( )
   }

### Section 3C Consent-Scoped Proof Module

The system may generate a Consent Token (CT) that binds consent scope and expiry to a user identifier: [CT=\text{hash}(user_id\parallel scope\parallel expiry\parallel nonce). ] The CT conditions which BBFV components may be disclosed via RTI.

The system may produce a Consent Proof demonstrating that disclosures comply with CT. Consent Proofs may be implemented using zero-knowledge proofs, TEE attestations, or other cryptographic mechanisms.

### Section 3D Threat Model Mitigations

The system includes a threat model addressing data poisoning, model inversion, replay, and linkage attacks. Mitigations may include signed telemetry, differential privacy, secure enclaves, multi-party computation, anomaly detection, and rate-limited disclosures.

Anomalies detected by RTI or SGOK may trigger escalation to AMBER or RED tiers and generate regulator notifications.

### Section 3E Validation Test Protocols

Representative validation protocols include synthetic perturbation tests, cross-validation, drift-stress tests, and sensitivity analyses. Validation metrics may include false-positive rate, false-negative rate, calibration error, and stability under perturbation.

Validation results and calibration metadata may be recorded in safety envelopes and made available to authorized regulators under consent constraints.

Section 3F Cross-Agent Coordination

The SGOK may broadcast safety tiers to participating agents. Agents adjust task allocation, negotiation behavior, or execution priority based on received tiers. Agents may enforce constraints preventing acceptance of tasks requiring a safety tier lower than their current BBFV-derived tier.

### SECTION 4 EMBODIMENTS

Peptide-Behavior Embodiment—BMSV comprises peptide-modulated micro-signals (e.g., peptide-induced HRV shifts, peptide-modulated cognitive-load signatures). SGOK and RTI operate as described to enforce safety and provide selective disclosure.

Hormonal Embodiment—BMSV includes hormonal micro-signals (e.g., cortisol, melatonin, insulin).

Neurological Embodiment—BMSV includes neurological micro-signals (e.g., EEG micro-patterns, pupillometry).

Emotional Embodiment—BMSV includes valence, arousal, dominance vectors.

Environmental Embodiment—BMSV includes temperature, noise, light-modulated responses.

Multi-Modal Embodiment—Fusion of multiple biological modalities with dynamic weighting based on confidence and drift.

Consent-Scoped Embodiment—RTI discloses only BBFV components permitted by Consent Token.

Ledger-Anchored Embodiment—Safety envelopes and transitions anchored to tamper-evident ledger.

Explainability Embodiment—Counterfactual traces and influence maps for regulator audits.

### SECTION 5 ADVANTAGES

The invention provides an essential governance-layer architecture that is general, modular, and standard-like.

The invention enables cross-domain fusion of biological micro-signals, behavioral signals, and governance scoring for safety-conditioned orchestration.

The invention provides regulator-aligned transparency while preserving privacy via hashed artifacts, consent proofs, and secure processing.

The invention supports adaptive safety enforcement, multi-agent coordination, and future expansion to new biological modalities.

### SECTION 6 INTEGRATION

The BBFV, SGOK, and RTI collectively extend the IPS-based governance architecture of U.S. patent application Ser. No. 19/397,884. The BBFV introduces biological-behavioral fusion; the SGOK introduces drift-aware safety gating; and the RTI introduces privacy-preserving regulator transparency.

The invention is not limited to any specific biological modality, fusion operator, safety threshold, or regulator interface. All mathematical expressions, pseudocode, schemas, and examples herein are illustrative and non-limiting.

The invention may be implemented in hardware, software, firmware, distributed systems, multi-agent systems, or any combination thereof.

The scope of the invention is defined by the claims and encompasses all equivalents, variations, and extensions that fall within the essential architecture described herein. What is a claim:

1. A governance-layer system for safety-conditioned orchestration, comprising:
a Biological-Behavioral Fusion Vector (BBFV) module configured to receive one or more biological micro-signals and one or more behavioral signals and to produce a fused governance vector representing biological, behavioral, contextual, and temporal stability information;
a Safety-Gated Orchestration Kernel (SGOK) configured to consume the fused governance vector and to determine a safety tier for a subject or agent and to enforce safety-conditioned orchestration actions based on the determined safety tier; and
a Regulator Transparency Interface (RTI) configured to provide privacy-preserving, regulator-verifiable artifacts derived from the fused governance vector and from safety envelopes generated by the SGOK;
wherein the BBFV, SGOK, and RTI are modular and interoperable such that new biological modalities, fusion operators, or regulator disclosure profiles can be added without modification of the core primitives.

2. The system of claim 1, wherein the BBFV module comprises sub-vectors including a Biological Micro-Signal Vector (BMSV), a Behavioral Influence Vector (BIV), a Contextual Modulation Vector (CMV), and a Temporal Stability Vector (TSV).

3. The system of claim 1, wherein the BBFV module is configured to perform fusion using one or more fusion operators selected from the group consisting of attention-weighted fusion, gated mixture-of-experts, temporal graph transformers, conformal prediction, and linear combinations.

4. The system of claim 1, wherein one or more BBFV computations are performed within a Trusted Execution Environment (TEE) or equivalent secure processing environment to preserve privacy and integrity of raw biological data.

5. The system of claim 1, wherein the SGOK is configured to generate safety artifacts comprising Biological State Envelopes (BSEs), Safety Intervention Envelopes (SIEs), drift reports, and explainability traces, each artifact including hashed BBFV components, a safety tier, a drift coefficient, and a proof digest.

6. The system of claim 1, wherein the SGOK is configured to compute a drift coefficient (\delta_t) representing longitudinal deviation in temporal stability and to apply configurable thresholds (\theta_1,\theta_2) to map (\delta_t) to safety tiers including GREEN, AMBER, and RED.

7. The system of claim 1, wherein the RTI is configured to selectively disclose hashed or cryptographically committed BBFV artifacts, consent-scoped proofs, and ledger anchoring references to authorized regulators while withholding raw biological signals.

8. A method for governance-layer safety-conditioned orchestration, comprising:
receiving, at a fusion module, biological micro-signals and behavioral signals from one or more sensing sources;
computing, by the fusion module, a Biological-Behavioral Fusion Vector (BBFV) that encodes biological, behavioral, contextual, and temporal stability information;
computing, by a Safety-Gated Orchestration Kernel (SGOK), a safety tier for a subject or agent based at least in part on the BBFV and on a drift coefficient derived from temporal stability information;
enforcing, by the SGOK, one or more safety-conditioned orchestration actions including task suspension, human-in-the-loop review, reduced task complexity, or machine-state transitions when the safety tier meets a configured escalation condition; and
providing, via a Regulator Transparency Interface (RTI), privacy-preserving, regulator-verifiable artifacts derived from the BBFV and from safety envelopes generated by the SGOK.

9. The method of claim 8, further comprising generating a Consent Token bound to a user identifier and consent scope, and conditioning RTI disclosures on verification of the Consent Token.

10. The method of claim 8, wherein computing the drift coefficient comprises computing (\delta_t=\lVert TSV_t−\overline{TSV}_{t−L}\rVert_2) for a lookback window (L), and wherein escalation conditions are defined by thresholds (\theta_1,\theta_2).

11. The method of claim 8, further comprising anchoring safety envelopes to a tamper-evident ledger and returning a ledger anchoring reference as part of RTI disclosures.

12. The method of claim 8, further comprising performing validation protocols including synthetic perturbation tests, cross-validation, and drift-stress tests, and recording validation metadata in safety envelopes.

13. The method of claim 8, further comprising broadcasting safety tiers to multiple agents and enforcing cross-agent coordination constraints such that agents do not accept tasks requiring a safety tier lower than their current BBFV-derived tier.

14. The method of claim 8, wherein RTI disclosures include cryptographic proofs selected from zero-knowledge proofs, TEE attestations, or signed proof digests that demonstrate compliance with consent and disclosure policies without revealing raw biological data.

15. A non-transitory computer-readable medium storing instructions that, when executed by one or more processors, cause a computing system to perform operations comprising:
receiving biological micro-signals and behavioral signals;
computing a Biological-Behavioral Fusion Vector (BBFV) from the received signals;
determining a safety tier based on the BBFV and on a computed drift coefficient;
generating safety envelopes and proof digests corresponding to the safety tier;
anchoring one or more safety envelopes to a tamper-evident ledger; and
responding to regulator queries by returning privacy-preserving artifacts derived from the BBFV and from anchored safety envelopes.

16. The medium of claim 15, wherein the stored instructions further cause the computing system to implement schema versioning for BBFV components and to expose adapter interfaces for adding new biological modalities or new fusion operators without modification of the core primitives.

17. The medium of claim 15, wherein the stored instructions further cause the computing system to implement anomaly detection that monitors disclosure patterns, drift anomalies, and tampering attempts and to escalate to a RED safety tier upon detection of a defined anomaly signature.

18. The medium of claim 15, wherein the stored instructions further cause the computing system to implement explainability generation that produces counterfactual traces comparing BBFV outputs with and without specified biological or behavioral components for regulator-aligned audits.

19. The medium of claim 15, wherein one or more BBFV sub-vectors include peptide-modulated physiological features as a flagship embodiment, the peptide features being illustrative and non-limiting of other biological modalities.

20. The medium of claim 15, wherein the stored instructions further cause the computing system to enforce consent-scoped disclosure rules by verifying a Consent Token prior to releasing any regulator-facing artifact.
